(19) United States
(12) Patent Application Publication
(10) Pub. No.: US 2004/0110614 A1
(43) Pub. Date: Jun. 10, 2004

(54) Machine center with two machining devices with tool change position

(75) Inventors: Norbert Hessbruggen, Salach (DE); Jurgen Walz, Frickenhausen (DE)

Correspondence Address: THE FIRM OF KARL F ROSS, 5676 RIVERDALE AVENUE, PO BOX 900, RIVERDALE (BRONX), NY, 10471-0900, US

(73) Assignee: EMAG Maschinenfabrik GmbH

(21) Appl. No.: 10/622,441

(22) Filed: Jul. 18, 2003

(30) Foreign Application Priority Data
Dec. 10, 2002 (DE) 10257533.9

(51) Int. Cl. B23Q 3/157

(52) U.S. Cl. 483/18

(57) ABSTRACT

A machining center, especially a self-loading machining center has a plurality of machining devices and an automatic tool-replacement system. The transport device delivers a workpiece to and receives a workpiece from a workpiece holder on a machine base between longitudinal rails on which the workpiece holder is guided. The workpiece holder carries the workpieces into the operating ranges of a pair of machining devices which can be shifted from the machining position into the tool-change position alternately. The machining feed is provided by the workpiece holder.

### SPECIFICATION

1. Field of the Invention

Our present invention relates to a machine tool and, more particularly, to a self-loading machining center having a plurality of machining devices and an automatic tool-replacement facility. The invention especially relates to a machining center having at least two machining devices with tools rotatable about respective axes which can be positioned for automatic tool replacement.

2. Background of the Invention

A machining center having two driven machining spindles is described for example, in EP 0 806 998 B1. These machining spindles can be shiftable parallel to their axes of rotation in horizontal directions. In addition, each of these machining spindles is displaceable in the vertical direction. The machining of a workpiece is effected by bringing the workpiece alternately into engagement with the tools on these machining spindles. To replace the tools, the machining spindles are shifted into positions behind a tool magazine and each spindle can pick up a replacement tool during advance toward the machining position once again.

The tool magazine in this system must be of considerable height and can be swung into a lower position to enable insertion of the tools therein. Because of this replacement, sufficient space must be provided between the workpiece carrier and the tool magazine to enable the swinging movement of the latter, especially when large workpieces are to be machined. The vertical movement required for the tool replacement is then determined by the height of the largest workpieces to be machined and this makes the replacement path even for small or smaller workpieces considerable. The long paths required for tool displacement and for the displacement of the workpiece increases significantly the time for machining for practically all workpieces. This is a major drawback in machining centers designed to process large numbers of workpieces in the shortest possible time.

A further machining center is known from EP 0 767 721 B1 in a knee-type construction with a multiplicity of machining units. To minimize the time for processing workpieces, the workpieces are held in a palette by means of clamping devices and are positioned by a workpiece carrier. A tool magazine for feeding the two machining heads is not disclosed in this arrangement. The knee-type construction and the one-sided guidance of the workpiece spindle has a detrimental effect on the stiffness of the machine and thus upon its accuracy.

### OBJECTS OF THE INVENTION

It is, therefore, the principal object of the present invention to provide a machining center which is capable of overcoming the drawbacks discussed above and in particular for minimizing the cycling time for the machining of workpieces.

Another object of this invention is to provide an improved machining center which has a reduced displacement of the tool by comparison with earlier machining centers and which thus enables tool replacement time to be shortened and yet has a high stability and stiffness such that high machining precisions are obtainable.

### SUMMARY OF THE INVENTION

These objects and others which will become apparent hereinafter are attained, in accordance with the invention, in a machining center which comprises:

a machine base provided with rails;

a workpiece support proximal to the machine base and adapted to hold at least one workpiece to be machined;

a workpiece holder on the machine base movable on the rails on the base between a pick-up position in which a workpiece is acquired by the holder from the workpiece support, to a machining station in which a workpiece on the holder is machined and back to a position in which the workpiece holder can release a machined workpiece onto the workpiece support, the holder retaining the workpiece between the rails during movement between the positions and the machining station;

at least two machining devices on the base at the machining station having respective machining tools rotatable about respective axes on the respective device;

drives for relatively displacing the holder and the machining devices to bring the workpiece into machining relationship with the tools at respective machining positions of each of the devices at the machining station; and

respective tool-change positions for each of the machining devices spaced from the respective machining position in a direction parallel to a respective rotation axis of the respective device whereby each of the devices is shiftable parallel to the respective rotation axis from the respective machining position to the respective tool-change position.

The invention is based upon our discovery that the time for machining workpieces can be significantly reduced by providing a pickup region for the workpieces and also the tool magazine in the alternate positions for the machining units in the direct proximity to the machining station so that the sum of the displacement for the workpiece and the tool change can be significantly reduced and a substantial saving in time can be realized in the machining of the workpieces.

With the machining center in accordance with the invention, a transport device can be provided for the workpieces, together with a pickup device or workpiece holder and at least two machining devices on the machine base so that the workpi ce can pass from one to the other with a minimum of travel. The workpiece holder can comprise a workpiece spindle with a chuck carried by a cross slide. The workpiece spindle operates in accordance with the pickup principle and can be swingable about a pivot axis which can lie at right angles to both movement directions of the cross slide. Advantageously, the two directions of movement of the cross slide, determined by two pairs of rails which are mutually perpendicular can include a vertical direction and a horizontal direction and the pivot axis previously mentioned can be horizontal.

For the machining of the workpiece typical machining tools can be provided in the two machining devices and these include tools for turning, milling, boring, grinding or the like. The tools are held in a tool magazine from which they can be removed as required and by means of a tool changer inserted into the machining devices upon tool replacement.

Advantageously, the tool magazine comprises an endless chain which can advance the tool in succession into the replacement region in the direct vicinity of the two machining devices and conveys the tools past them. To exchange the tools, each of the machining devices is moved in turn into a replacement region or tool-changing position. There a tool changer, preferably a double gripper, engages the tool to be replaced and a replacement tool from the machining head and the magazine, respectiv ly, and switches one for the other. According to a particularly advantageous embodiment of the invention, the machining is shifted parallel to the rotation axis of its tool into and out of the tool change position. The displacement stroke is thus no longer dependent on the size of the workpiece to be machined and can be significantly shorter than the tool change stroke required in prior art systems.

According to a further feature of the invention each of the machining devices is assigned a separate tool magazine. Preferably disk magazines are provided, in this case, which are disposed laterally of the machining device and parallel to its rotation axis. An especially space-saving arrangement is obtained when the tool replacement involves a swinging unit which is capable of swinging a tool retrieved from the magazine through 90°. A tool changer, preferably again a double gripper, can then switch the tools in the machining head or device for the tool held in readiness by the swinging unit.

According to the invention, the machining center can be provided with a transport device for the workpieces laterally of but in proximity to the machining devices. By having the workpieces held in readiness close to the machining devices and the workpiece support for receiving the machined workpiece close to the machining devices, the transport path for the workpieces can be especially short. Since the two machining devices or heads can be closely adjacent one another as well, the path of the workpieces for the entire machining cycle can be extremely short. In addition, since the two machining devices or heads operate alternately, while one is machining the other is having its tool replaced so that the dead time in the machining process is minimized or eliminated entirely. Since practically there is no period in which no machining takes place, the machining cycle is optimal and multiple machining operations can be carried out in the machining center during each machining cycle in the shortest possible time.

### BRIEF DESCRIPTION OF THE DRAWING

The above and other objects, features, and advantages will become more readily apparent from the following description, reference being made to the accompanying drawing in which:

FIG. 1 is a diagrammatic cross sectional view through a machining center according to the invention;

FIG. 2 is a longitudinal section through the machining center; and

FIG. 3 is a view similar to FIG. 2 but illustrating a modification of the machining center.

### SPECIFIC DESCRIPTION

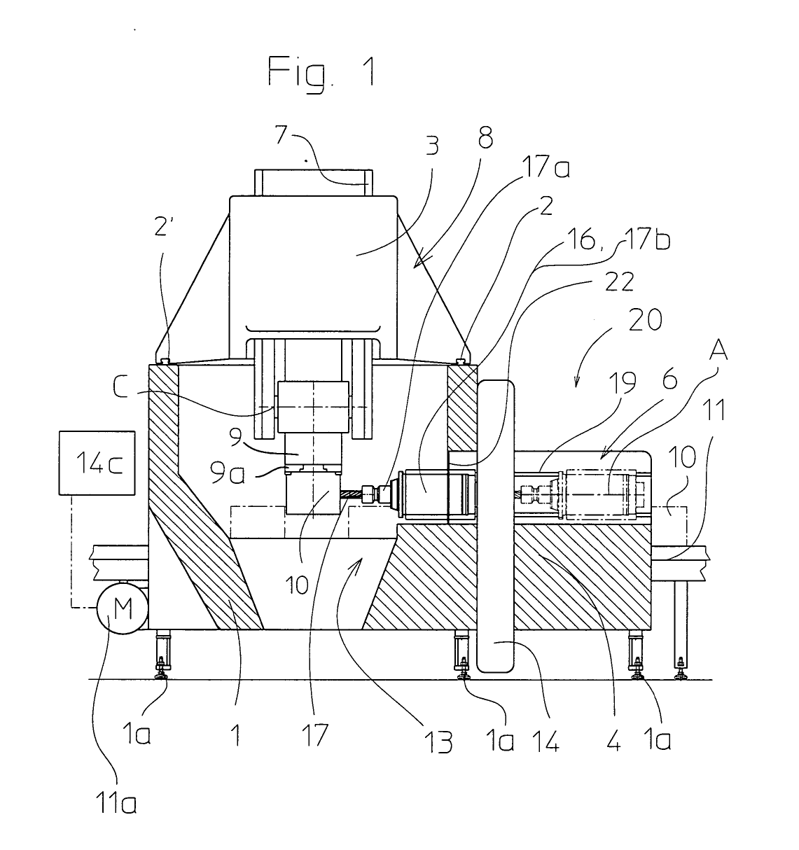

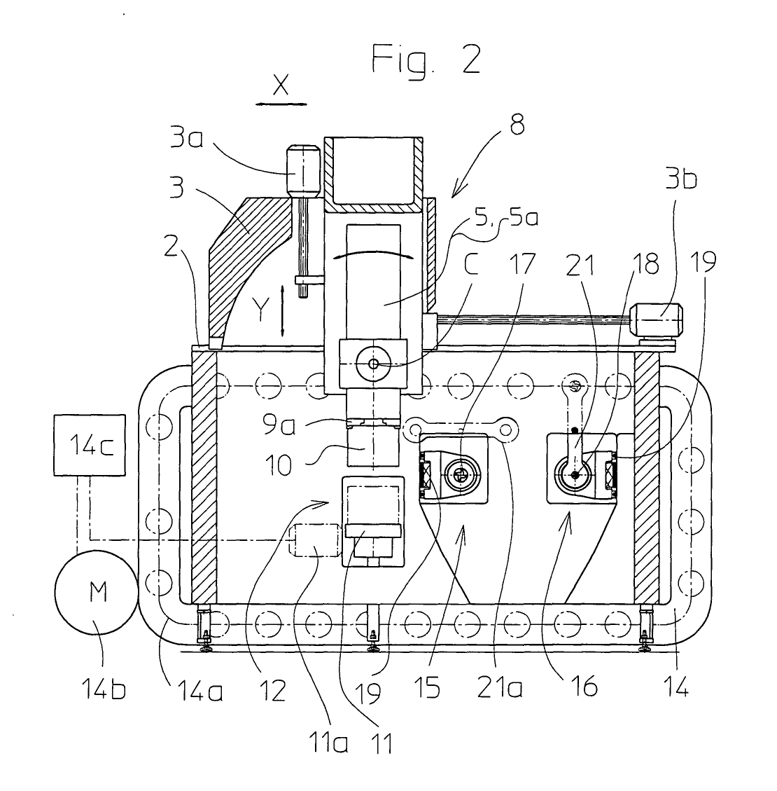

FIG. 1 is a cross section of a machining center which has a rigid base 1 mounted upon leveling feet 1a and provided with guide rails 2, 2′ extending longitudinally and, in FIG. 1, horizontally perpendicular to the plane of the paper. A cross slide 3 is displaceable along the rails 2, 2′ in the longitudinal direction and carries a transvers guide 7 lik wise form d by a pair of rails upon which workpiece holder 8 is shiftable, e.g. in the vertical direction. The directions of displacement provided by the cross slide are shown at X and Y in FIG. 2. A linear drive is connected to the tool holder 8 to displace it in the Y direction along the guide 7 while a further linear drive 3b is connected to the cross slide 3 to displace it in the longitudinal direction along the rails 2.

The workpiece holder 8 is provided with a workpiece spindle 5.

The linear drive may be rack and pinion drives, screw drives, linear motors or the like.

At the lower end, the workpiece spindle 5 is provided with a jaw-type chuck which can grip and clamp a workpiece 10 to be machined. The workpiece spindle 5 can be rotated by a motor 5a shown only diagrammatically in FIG. 2 and, in addition, the workpiece spindle 5 itself can be swung about a pivot axis C which is perpendicular to the directions X and Y and hence to the rails 2, 2′ on the one hand and the guide 7 on the other. Jaws of the chuck 9 have been represented at 9a in FIGS. 1 and 2.

The machining center comprises two machining units 15 or devices 16 which are provided at a machining station 13 which has also been referred to as a machining region.

Each of the machining devices comprises a respective spindle carrying a tool 17. A milling cutter is shown as the tool 17 in FIGS. 1 and 2. The spindle carrying the tool has been represented at 17a and can b driven by a motor diagrammatically indicated at 17b in FIG. 1.

Each of the machining units 15 and 16 can be mounted on rails 19 forming a guide path perpendicular to the plane of the paper in FIG. 2 but parallel to the plane of the paper in FIG. 1 and which is horizontal and thus perpendicular to the X and Y direction and parallel to the axis C. In FIG. 1 the tool axis A of the tool 17 of the machining unit 16 has been shown and it will be apparent that the machining device or head 16 is displaceable parallel to the axis A from the machining position shown in FIG. 1 into a tool-change position 6 shown in dot-dash lines in FIG. 1. This position lies in the tool-change region 20. In this region the base 1 is enlarged by a supporting member 4 (FIG. 1). The tool-change region 20 can be shielded by a dirt diverter 22, e.g. a displaceable partition or curtain, preventing contaminants from the machining region 13 from entering the tool-change region 20.

For the machining of the workpiece 10, a multiplicity of different tools are provided in the tool magazine 14 which, as can be seen from FIG. 2, has an endless chain 14a controlled by a motor or drive 14b and operated by the machining center computer 14c for positioning the proper tool at the two tool-change positions 6 of the machining heads 15 and 16 as required. The tools can include those typically used in machining centers, for example, the machining operations of turning, milling, drilling, boring, thread cutting, grinding and recessing, etc.

The apparatus also includes a transport device 11 provided with a drive 11a and likewise connected to the computer 14c for delivery of the workpieces 10 to the base of the machining center and transporting away the machined workpieces. The transporter 11 extends into a pickup region 12 of the base (FIG. 2) from which the chuck 9 can pick up a workpiece to be machined and drop off a workpiece which has been machined. The pickup and drop off regions can coincide or practically coincide.

From FIG. 2 it will be apparent that the workpiece holder 8 extends between the two rails 2 AND 2′.

A machining cycle begins with the removal of a workpiece 10 in the pickup region 12 from the transport device 11. The workpiece holder 8 carries the workpiece into the machining region 13. There the workpiece is initially brought into the effective region of the machining head 15 and by the relative movement between the workpiece holder 8 and the machining head 15 is machined by the tool 17 of the latter. In this movement, the tool holder is displaced along the rails 2, 2′ and/or the guide 7 with the feed movements required for the machining. The positioning of the tool for this machining operation is effected by displacement of the machining head 15 into its machining position from the tool-change position 6, i.e. by movement of the head 15 to the left in FIG. 1.

In FIG. 2 the machining device or head 16 is shown in its tool-change position. The tool changer 21, preferably a double gripper, engages the tool 18 in the head 16 and switches it for another tool from the tool magazine 14. Following the tool change and a machining step using the machining head 15 and the tool 17 therein, the workpiece holder 8 shifts the workpiece into the operating range of the machining head 16 and the new tool therein. Machining is carried out in a manner analogous to that performed by the machining head 15. During this period the machining head 15 is shifted into the tool-change position and undergoes tool replacement utilizing a respective double gripper 21a. After this tool change the holder 8 shifts the workpiece 10 back into the effective range of the new tool in the head 15. The alternating tool replacement and machining being carried out until the machining operations on the workpiece are complete. The workpiece can be rotated during the machining operation by the motor 5a. Following the machining the workpiece is carried back to the transporter 11 and deposited in the place from which it was lifted. The transporter is then displaced by the motor 11a described previously.

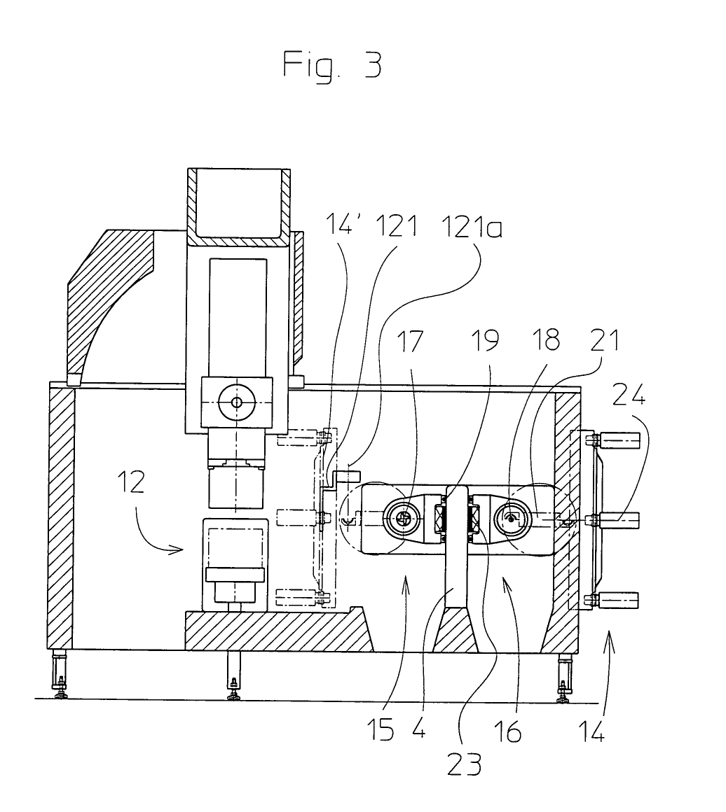

FIG. 3 shows a longitudinal section through a machining center in a modified form. The machining devices or heads 15 and 16 here lie on the opposite side of a common support 4. For each of the two machining heads, there is a separate disk-shaped tool magazine 14, 14′ which is disposed laterally of the respective machining head and parallel to the rotation axes of the tool thereof.

A swinging device represented diagrammatically at 121 is provided which can be rotated about a vertical axis 121a through 90°, to swing a tool remov d from the magazine 14 or 14′ and position it so that a respective double gripper similar to that shown at 21 or 21a can insert it into the head 15 or 16 and substitute it for the tool previously used for machining therein. The tools in the magazine have been represented at 24. The swinging device has been illustrated only diagrammatically.

The tool in the swinging device 121 is considered to be held in readiness for replacement for the tool in the machining head by the double gripper 21.

The machining head or devices 15 and 16 are displaced by linear drives represented at 23 which can be arranged between the rails 19.

Because of the spatial compact arrangement of the pickup region 12, the machining devices 15 and 16 and the tool-change region 20, the sum of the displacements or stroke for the workpiece and tool replacement can be significantly shortened and the combination of tool replacement and machining can be carried out at a significantly reduced cycling time by comparison with earlier systems.

We claim:

1. A machining center comprising:
a machine base provided with rails;
a workpiece support proximal to said machine base and adapted to hold at least one workpiece to be machined;
a workpiece holder on said machine base movable on said rails on said base between a pick-up position in which a workpiece is acquired by said holder from said workpiece support, to a machining station in which a workpiece on said holder is machined and back to a position in which said workpiece holder can release a machined workpiece onto said workpiece support, said holder retaining said workpiece between said rails during movement between said positions and said machining station;
at least two machining devices on said base at said machining station having respective machining tools rotatable about respective axes on the respective device;
drives for relatively displacing said holder and said machining devices to bring said workpiece into machining relationship with said tools at respective machining positions of each of said devices at the machining station; and
respective tool-change positions for each of said machining devices spaced from the respective machining position in a direction parallel to a respective rotation axis of the respective device whereby each of said devices is shiftabl parallel to the respective rotation axis from the resp ctive machining position to the respective tool-change position.

2. The machining center defined in claim 1 wherein said workpiece holder comprises a workpiece spindle provided with a jaw chuck adapted top grip said workpiece.

3. The machining center defined in claim 2 wherein said workpiece spindle is mounted on a cross slide displaceable on said rails and on a guide perpendicular to said rails.

4. The machining center defined in claim 3 wherein said spindle is swingable about an axis on said holder perpendicular to said rails and to said guide.

5. The machining center defined in claim 3 wherein said workpiece holder is provided with a drive imparting a feed movement to said workpiece for machining thereof by a respective one of said tools at said machining station.

6. The machining center defined in claim 1 wherein each of said machining devices is provided with a drive capable of presenting the respective tool at the respective machining position and retracting the respective tool into a respective tool-change position.

7. The machining center defined in claim 6, further comprising a support element carrying respective guides for said machining devices enabling the displacement of said machining devices between the respective machining position and the respective tool-change position.

8. The machining center defined in claim 7 wherein said support element is rigid with or one piece with said base.

9. The machining center defined in claim 8 wherein the guides for said machining devices are disposed outside said machining station.

10. The machining center defined in claim 1, further comprising a shield preventing contaminants from said machining station from passing into said tool-change positions.

11. The machining center defined in claim 1 wherein said shield is a dirt deflector located between the machining and tool-change positions.

12. The machining center defined in claim 7 wherein said machining devices are located on opposite sides of said support element.

13. The machining center defined in claim 1, further comprising at least one tool magazine accessible at said tool-change positions for supplying replacement tools to said tool-change positions.

14. The machining center defined in claim 13 wherein each of said machining devices is provided with a respective tool magazine.

15. The machining center defined in claim 13, further comprising a respective tool changer at each of said tool-change positions for removing a tool from a magazine and inserting it into the respective machining device.

16. The machining center defined in claim 1, further comprising a transport device for advancing workpieces in succession into said pickup position and carrying a machined workpiece away from said pickup position, whereby each workpiece is picked up and dropped off by said workpiece holder at the same place.
